(19) United States
(12) Patent Application Publication
(10) Pub. No.: US 2026/0074429 A1
(43) Pub. Date: Mar. 12, 2026

(54) Apparatuses With Slot Antennas

(71) Applicant: Anhui Huami Health Technology Co., Ltd., Hefei (CN)

(72) Inventors: Zhouyou Ren, Hefei (CN); Anping Zhao, Hefei (CN); Mingyang Li, Hefei (CN)

(21) Appl. No.: 19/393,057

(22) Filed: Nov. 18, 2025

Related U.S. Application Data
(63) Continuation-in-part of application No. 18/316,760, filed on May 12, 2023, now Pat. No. 12,506,256.
Application No. 18/316,760 is a continuation of application No. PCT/CN2021/122557, filed on Oct. 8, 2021.

(30) Foreign Application Priority Data
Nov. 25, 2020 (CN) 202011345510.4
Nov. 25, 2020 (CN) 202022761117.5

(51) Int. Cl. H01Q 13/10; H01Q 1/38; H01Q 1/50; H01Q 9/04

(52) U.S. Cl. CPC H01Q 13/10; H01Q 1/38; H01Q 1/50; H01Q 9/0435

(57) ABSTRACT

A device may include a mainboard including a grounding unit, a radio-frequency circuit, and a conductor, wherein an annular radiation slot is provided on the conductor. The device may include a feeding terminal having a first end connected to a feeding point of the conductor and a second end electrically connected to the radio-frequency circuit of the mainboard. The device may include a first inductor having a first end connected to a grounding point of the conductor and a second end electrically connected to the grounding unit of the mainboard. The device may include a first capacitor provided in the annular radiation slot and having two electrodes respectively connected to both ends of the annular radiation slot in a width direction of the annular radiation slot, located between the feeding terminal and the first inductor in a length direction of the annular radiation slot.

### CROSS-REFERENCE TO RELATED APPLICATION(S)

The present application disclosure is a continuation-in-part of U.S. application Ser. No. 18/316,760, filed May 12, 2023, which is a continuation of International Application No. PCT/CN2021/122557, filed Oct. 8, 2021, which claims priority and benefit of Chinese Patent Application Nos. 202011345510.4 and 202022761117.5, both filed on Nov. 25, 2020, the entire contents of all of which are incorporated herein by reference.

### TECHNICAL FIELD

The present disclosure relates to the technical field of electronic devices, and in particular to an apparatus with a slot antenna.

### BACKGROUND

With the development of electronic devices, smart wearable devices can achieve more and more functions. Taking a smartwatch as an example, it has functions such as motion assistance, satellite positioning, wireless connection, and communication, all of which can be achieved by means of a built-in antenna of the watch.

In order to pursue the aesthetics and texture of the appearance, more and more smart wearable devices are made of metal materials, while achieving antenna functions by using slot antenna structures. For wearable devices, they often have small sizes, and thus have limited design space for antennas, making them difficult to implement antennas with multiple frequency bands. Taking smartwatches as an example, due to the size limitation, it is difficult to implement dual-band GPS antenna design by using a slot antenna in the related art.

### SUMMARY

In order to solve the technical problem of designing a multi-band antenna for an electronic device, embodiments of the present disclosure provide an apparatus with a slot antenna.

In some aspects, the techniques described herein relate to an apparatus with a slot antenna, including: a mainboard including a grounding unit and a radio-frequency circuit; a conductor, wherein an annular radiation slot is provided on the conductor; a feeding terminal, the feeding terminal having a first end connected to a feeding point of the conductor, and a second end electrically connected to the radio-frequency circuit of the mainboard; a first inductor, the first inductor having a first end connected to a grounding point of the conductor, and a second end electrically connected to the grounding unit of the mainboard; and a first capacitor provided in the annular radiation slot and having two electrodes respectively connected to both ends of the annular radiation slot in a width direction of the annular radiation slot, wherein the first capacitor is located between the feeding terminal and the first inductor in a length direction of the annular radiation slot; wherein an operating frequency of the slot antenna includes a resonant frequency band of each of at least two resonant modes of the annular radiation slot.

In some aspects, the techniques described herein relate to an apparatus with a slot antenna, including: an annular radiation slot formed in the apparatus; a feeding terminal, the feeding terminal having a first end connected to a feeding point of the slot antenna, and a second end electrically connected to a radio-frequency circuit of the apparatus; a first inductor, the first inductor having a first end connected to a grounding point of the slot antenna, and a second end electrically connected to a grounding unit of the apparatus; and a first capacitor provided in the annular radiation slot and having two electrodes respectively connected to both ends of the annular radiation slot in a width direction of the annular radiation slot, wherein the first capacitor is located between the feeding terminal and the first inductor in a length direction of the annular radiation slot, wherein an operating frequency of the slot antenna includes a resonant frequency band of each of at least two resonant modes of the annular radiation slot.

### BRIEF DESCRIPTION OF DRAWINGS

In order to explain technical solutions in DETAILED DESCRIPTION OF THE EMBODIMENTS of the present disclosure or in the related art more clearly, the drawings to be used in the DETAILED DESCRIPTION or description of the related art will be briefly introduced below. It is apparent that the drawings in the following description illustrate some embodiments of the present disclosure. For those ordinary skilled in the art, other drawings can be obtained from these drawings without much creative effort.

FIG. 1A is an exploded view illustrating a structure of a terminal device according to some embodiments of the present disclosure.

FIG. 1B is a sectional view of an example apparatus having a metal bezel, according to some embodiments of the present disclosure.

FIG. 1C is a sectional view of an example apparatus in which a slot is provided on a metal side portion of the apparatus, according to some embodiments of the present disclosure.

FIG. 2 is a schematic diagram illustrating a dual-band slot antenna according to some embodiments of the present disclosure.

FIG. 3 is a schematic diagram illustrating a current distribution of an antenna at a first-order resonant frequency according to some embodiments of the present disclosure.

FIG. 4 is a schematic diagram illustrating a current distribution of an antenna at a second-order resonant frequency according to some embodiments of the present disclosure.

FIG. 5 is a schematic diagram illustrating a current distribution of an antenna at a third-order resonant frequency according to some embodiments of the present disclosure.

FIG. 6 is a graph illustrating a change in an S-parameter of an antenna with a first capacitor applied at a zero position of voltage.

FIG. 7 is a schematic diagram illustrating a current distribution of an antenna at a second-order resonant frequency after a first capacitor is applied at a zero position of voltage.

FIG. 8 is a graph illustrating a change in an S-parameter of an antenna with a first inductance after a first capacitor is applied.

FIG. 9 is a graph illustrating an S-parameter of an antenna according to an embodiment of the present disclosure.

FIG. 10 is a graph illustrating an efficiency of an antenna according to an embodiment of the present disclosure.

FIG. 11 is a schematic structural diagram illustrating an antenna according to another embodiment of the present disclosure.

FIG. 12 is a schematic structural diagram illustrating an antenna according to yet another embodiment of the present disclosure.

### DETAILED DESCRIPTION

Technical solutions of the present disclosure will be clearly and completely described below in conjunction with the accompanying drawings. It is apparent that the described embodiments are part of the embodiments of the present disclosure, rather than all of the embodiments. All other embodiments obtained by those ordinary skilled in the art based on the embodiments of the present disclosure without any creative efforts shall fall within the protection scope of the present disclosure. In addition, technical features involved in different embodiments of the present disclosure described below can be combined with each other as long as they do not conflict with each other.

A slot antenna refers to an antenna formed by providing a slot on a surface of a conductor. For a typical slot antenna, such as, for example, a strip-shaped slot can be formed between a PCB (Printed Circuit Board) and a metal of the device, or, a strip-shaped slot can be provided on a metal housing, and a feeding terminal connected across the slot serves as an excitation source of the antenna.

The operating principle of the slot antenna is similar to that of a dipole antenna. Generally, a length of the slot is half of a wavelength corresponding to a first-order resonant frequency of the antenna, that is, the relationship between a slot length L of the slot antenna and the wavelength λ corresponding to an operating frequency of the antenna is as follows:

$$L = \frac{1}{2} λ = \frac{1}{2} \cdot \frac{C}{f} \qquad ( 1 )$$

In Equation (1), C represents the speed of light, and f represents the first-order resonant frequency. It can be seen from the Equation (1) that, the length L of the slot is inversely proportional to the operating frequency f of the antenna, that is, the lower the operating frequency of the antenna, the longer the required length of the slot.

Taking the GPS satellite positioning system as an example, frequency bands of the GPS satellite positioning system for civil use include L1 frequency band and L5 frequency band. The center frequency of the L1 frequency band is 1.575 GHz, and the center frequency of the L5 frequency band is 1.176 GHz. Since the satellite coverage of the L1 frequency band is larger, the L1 frequency band usually serves as the fundamental GPS operating frequency band, and a single-band GPS antenna refers to an antenna that supports only the L1 frequency band. A dual-band GPS antenna supports both the L1 frequency band and the L5 frequency band, with the L1 frequency band serving as the fundamental frequency band, and the L5 frequency band serving as the auxiliary frequency band, such that ionospheric errors can be eliminated, and the positioning accuracy can be greatly improved.

It can be seen from the calculation of the Equation (1) that, half of the L1 wavelength of the GPS satellite positioning system in free space is about 95 mm, and half of the L5 wavelength of the GPS satellite positioning system in free space is about 127 mm. For some terminal devices, such as typical smartwatches, due to the limited space in the watches, it is impossible to make the slot antennas in the watches covering both the L1 frequency band and the L5 frequency band of the GPS, and Bluetooth/WiFi antennas are always required for the wearable devices, which further compress the internal space of the devices. As a result, it is difficult to realize dual-band GPS satellite positioning systems in some terminal devices, resulting in low positioning accuracy of the devices.

In order to solve the above technical problems, embodiments of the present disclosure provide an apparatus with a slot antenna. The apparatus can be any device with a slot antenna structure, e.g., a handheld device such as a smart phone or a tablet computer, or a wrist-worn device such as a smartwatch or a smart bracelet, and so on, which is not limited in the present disclosure. The apparatus according to the embodiments of the present disclosure aims to achieve dual-frequency or multi-frequency multiplexing by utilizing multiple orders of the resonant frequencies of the slot antenna, and can realize a multi-band antenna structure in the apparatus with a relatively small space, such as, for example, the design of a dual-band GPS antenna in the volume of a smart watch or bracelet. Therefore, the apparatus according to the present disclosure has a better performance in a terminal device with a relatively small size, such as a wrist-worn device. However, the apparatus according to the present disclosure is also applicable to any other device with a slot antenna, and can have similar effect, which is not limited by the present disclosure.

In some embodiments, the present disclosure provides an apparatus with a slot antenna, including: a slot formed in the apparatus, and a feeding terminal and a first inductor both bridged across the slot. The slot may be a gap formed between a mainboard and a conductor of the apparatus, where the conductor may be a portion of the housing of the apparatus, such as a metal middle frame, a metal bezel, or the like. Alternatively, the slot may be a gap provided on a metal housing of the apparatus, such as a side portion of the housing or the like, and the present disclosure is not limited thereto.

One end of the feeding terminal is connected to a feeding point of the antenna across the slot, and the other end of the feeding terminal is connected to a radio-frequency circuit on the mainboard of the apparatus, such that the feeding terminal serves as an excitation source of the antenna. One end of the first inductor is electrically connected to a grounding point of the antenna across the slot, and the other end of the first inductor is electrically connected to a grounding unit of the mainboard of the apparatus, such that the first inductor serves as a grounding terminal of the antenna. That is, a gap between the feeding terminal and the first inductor serves as a radiation slot of the antenna. A first capacitor is provided between the feeding terminal and the first inductor in a length direction of the slot, and electrodes at two ends of the first capacitor are connected to two ends of the slot in a width direction, respectively. At least one order of the resonant frequencies (i.e., a resonant frequency band of each of at least one resonant mode) of the antenna is adjusted with the first capacitor and the first inductor.

According to the embodiments of the present disclosure, the first capacitor and the first inductor are provided to the slot antenna, and a frequency multiplication relationship among the multiple orders of the resonant frequencies of the slot antenna is adjusted, such that the multiple orders of the resonant frequencies are adjusted to available operating frequencies, and requirements of multiple operating frequency bands can be met with a single antenna structure.

Based on the principle of the slot antenna, when the slot antenna is fed via the feeding terminal, the slot antenna can generate the multiple orders of resonant frequencies having a frequency multiplication relationship thereamong. For a single-band antenna, the first-order resonant mode (also referred to as “fundamental mode”) of the multiple orders of resonant frequencies is available. The “multi-band antenna” described in the present disclosure refers to utilizing two or more orders of resonant frequencies (i.e., resonant frequencies of two or more resonant modes) of a same slot antenna structure.

For example, for the same slot antenna, if one order of the resonant frequencies is 1.176 GHz and another order of the resonant frequencies is 1.575 GHz, the antenna covers both the L1 frequency band and the L5 frequency band of the GPS. However, it can be seen from the foregoing that, the multiple orders of resonant frequencies of the slot antenna have the frequency multiplication relationship thereamong. Taking the first three orders of the resonant frequencies as an example, if the first-order resonant frequency is f₀, the second-order resonant frequency is 2f₀, and the third-order resonant frequency is 3f₀, this makes it impossible to directly use the multiple orders of resonant frequencies in most cases. For example, if the first-order resonant frequency of the slot antenna is 1.176 GHz, the second-order resonant frequency reaches 2.352 GHz, which is much higher than the center frequency 1.575 GHz of the L1 frequency band of the GPS.

Based on the above discussion, in the embodiments of the present disclosure, the first capacitor and the first inductor are configured to adjust the frequency multiplication relationship among the multiple orders of resonant frequencies of the slot antenna, so as to achieve the desired target frequencies. The use of a same antenna structure to realize a multi-band antenna greatly simplifies the structure of antenna in the apparatus, which will make it possible to implement antenna structures that were previously impossible to achieve in devices with relatively small sizes.

In order to facilitate a more intuitive understanding of the present disclosure, the present disclosure will be described below in conjunction with some particular embodiments. In the embodiments, a smartwatch is used as an example of the apparatus, and the slot antenna is used to realize a dual-band GPS antenna as an example. It can be seen from the foregoing that, it is difficult to implement a dual-band GPS antenna by using a slot antenna structure due to the limited space in the smartwatch, and these embodiments are directed to the design of the dual-band GPS antenna in the smartwatch. It should be understood that, the slot antenna structure is also applicable to other types of wearable devices with a limited space, and that other types of antenna may likewise be implemented.

In some embodiments, the slot antenna structure is formed by a slot between the main board and a conductor. The conductor may be provided within the housing of the apparatus or provided on the housing. Alternatively, the conductor may be a part of the housing. For example, the housing of the apparatus may include a bottom case and a side portion, and the conductor may include at least a part of the side portion.

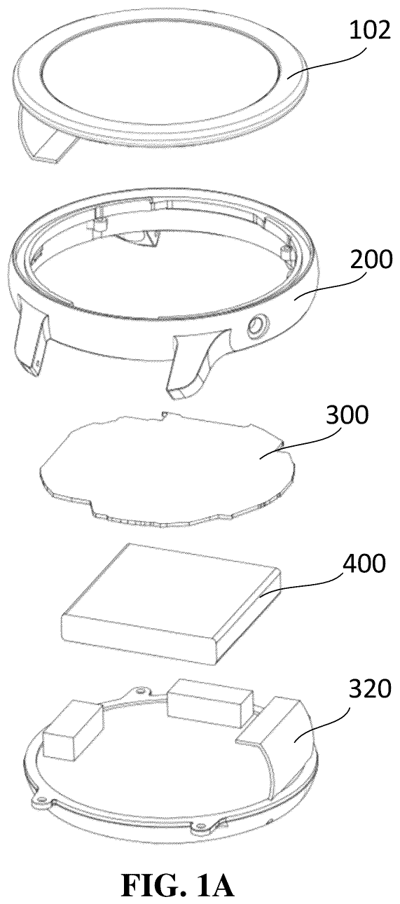

As shown in FIG. 1A, the apparatus can be a smartwatch in the present example, which includes a screen assembly 102, a metal middle frame 200, a mainboard 300, a battery 400, and a bottom case 320. In the present example, a slot antenna is formed by feeding and grounding a slot between the mainboard 300 and the metal middle frame 200. the screen assembly 102 can include, for example, a display assembly. In some implementations, the apparatus can further include a metal bezel as will be discussed below. A mainboard (e.g., the mainboard 300) may be also referred to herein as printed circuit board (PCB) or a flexible printed circuit (FPC) board.

FIG. 1B is a sectional view of an example apparatus having a metal bezel 210, according to some embodiments of the present disclosure. As shown in FIG. 1B, the apparatus is shown in an example smartwatch having a slot antenna implemented by the metal bezel 210. The smartwatch includes the metal bezel 210, a display assembly 500, a mainboard 300, a middle frame 310, and a bottom case 320. In this example, the slot antenna is formed by feeding and grounding across a slot defined between the mainboard 300 and the metal bezel 210. The middle frame 310 may be made of a non-conductive material. Alternatively, an middle frame 310 may be made of a conductive material (e.g., the metal middle frame 200), and an insulating layer may be provided between the metal bezel 210 and the middle frame 310. The metal bezel 210 is disposed around a circumference of the mainboard 300 and positioned above the mainboard 300, a lower portion of the metal bezel 210 is connected to the middle frame 310, and a lower portion of the middle frame 310 is connected to the bottom case 320, thereby forming an integrated smartwatch enclosure together with the display assembly 500. The antenna feeding is implemented by connecting a feeding terminal extending from the metal bezel 210 to an elastic member 130 on the mainboard 300, such that the slot formed between the mainboard 300 and the metal bezel 210 functions as a slot antenna.

In both examples shown in FIG. 1A and FIG. 1B, both the slots formed between the mainboard and the conductor have unbroken annular structure, and the slot antenna structure corresponds to an entire circumference of the apparatus, such as a smartwatch. In some other examples, the slot antenna structure may be implemented with a slot between a conductor provided on the housing of the apparatus and the mainboard, such as a conductor attached to the non-conductive middle frame. In some other examples, the slot antenna structure may be implemented with a slot between a conductor provided within the housing and the mainboard, which is not limited in the present disclosure.

In some other implementations, the slot antenna structure may be implemented with a slot provided on a conductor. For example, the housing of the apparatus is made of one or more conductive materials, and the slot antenna structure is provided on the housing of the apparatus.

FIG. 1C is a sectional view of an example apparatus in which a slot is provided on a side portion of the apparatus, according to some embodiments of the present disclosure. As shown in FIG. 1C, the apparatus is shown in an example smartwatch having a slot antenna provided on the metal side portion of the smartwatch. Specifically, the smartwatch includes a display assembly 500, a metal bezel 210, a metal middle frame 310, a bottom case 320, and a mainboard 300. In this example, the slot antenna structure includes a slot between the metal bezel 210 and the metal middle frame 310, with an insulating ring 600 made of a non-conductive material provided therein. In this case, the metal bezel 210 and the metal middle frame may respectively serve as a first conductor portion and a second conductor portion of the conductor. The middle frame 310 is provided around the circumference of the mainboard 300, and the mainboard 300 is positioned between the upper and lower surfaces of the middle frame 310. A plurality of (e.g., at least four) electrical contact points 700 are provided between the mainboard 300 (e.g., the grounding unit of the mainboard 300) and the middle frame 310. The presence of these contact points electrically integrates the mainboard 300 and the middle frame 310 as a single structure, such that grounding of the slot is realized. A feeding terminal 110 connecting the mainboard 300 and the upper metal bezel 210 enables antenna excitation from the mainboard 300 to the metal bezel 210. In this example, since the mainboard 300 and the metal middle frame 310 are electrically integrated through the plurality of contact points 700, the feeding configuration described above effectively achieves feeding of the antenna slot. In an implementation, the apparatus may also include a shielding cover 190 as shown in FIG. 1C.

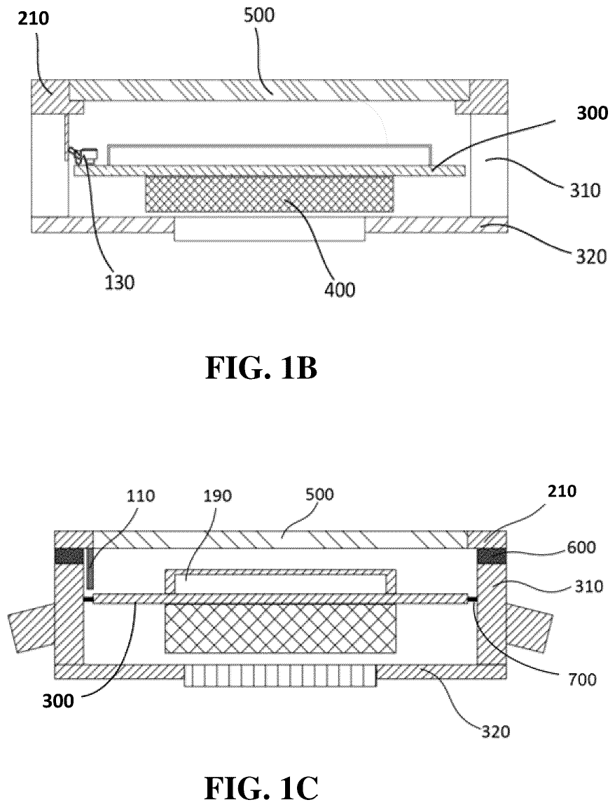

FIG. 2 shows a schematic diagram of the example structure of the slot antenna. In particular, as shown in FIG. 2, an annular slot 610 is formed between the mainboard 300 and the metal middle frame 200. A feeding terminal 620 is connected across the annular slot 610, with one end connected to the metal middle frame 200 as a feeding point, and the other end connected to a radio-frequency (RF) circuit on the mainboard 300. A first inductor 630 is connected across the annular slot 610, one end of the first inductor 630 is connected to the metal middle frame 200 as a grounding point, and the other end of the first inductor 630 is connected to a grounding unit of the mainboard 300. Thus, a slot antenna structure is formed between the feeding terminal 620 and the first inductor 630. It should be noted that the grounding unit of the apparatus in this embodiment can be implemented by a grounding unit of the mainboard 300, which serves as the system ground for the entire device, as will be understood by those skilled in the art.

It can be understood that, in this embodiment, instead of being grounded directly at the grounding point of the antenna, the antenna is grounded through the first inductor 630. According to the aforementioned principle of the slot antenna, grounding the antenna through the first inductor 630 is equivalent to increasing the effective electrical length of the antenna, such that the resonant frequency band of the slot antenna is shifted towards lower frequencies.

With continued reference to FIG. 2, a first capacitor 640 is connected across the annular slot 610, an electrode on one end of the first capacitor 640 is connected to the metal middle frame 200, and an electrode on the other end of the first capacitor 640 is connected to the grounding unit of the mainboard 300. The effective electrical length of the antenna can also be increased by providing a capacitor in the slot antenna, such that the resonant frequency band of the slot antenna is shifted towards lower frequencies.

On this basis, how to adjust two orders of resonant frequencies of the slot antenna to the center frequency of the L1 frequency band of the GPS and the center frequency of the L5 frequency band of the GPS are illustrated. For example, two orders of resonant frequencies (i.e., resonant frequency bands of two resonant modes) of the slot antenna include a first resonant frequency band and a second resonant frequency band.

First, considering that the center frequency of the L1 frequency band of the GPS is 1.575 GHz and the center frequency of the L5 frequency band of the GPS is 1.176 GHZ, the frequency multiplication relationship between these two center frequencies is that the center frequency of the L1 frequency band is about 1.34 times of the center frequency of the L5 frequency band. Based on the foregoing, it can be seen that, the first three orders of resonant frequencies of the slot antenna are f₀, 2f₀, and 3f₀, respectively, where the frequency multiplication relationship between the second-order resonant frequency and the third-order resonant frequency is that the third-order resonant frequency is 1.5 times of the second-order resonant frequency, which is closer to the frequency multiplication relationship between the L1 frequency band and the L5 frequency band. Therefore, in some embodiments, the second-order resonant frequency and the third-order resonant frequency of the slot antenna are used to realize the dual-band GPS antenna. For ease of description, the second-order resonant frequency of the slot antenna is served as the first resonant frequency (which may also be referred to as a resonant frequency band of a first resonant mode), and the third-order resonant frequency of the slot antenna is served as the second resonant frequency (which may also be referred to as a resonant frequency band of a second resonant mode) hereinafter.

In some embodiments of the present disclosure, the second-order resonant frequency and the third-order resonant frequency may be adjusted, so as to realize the dual-band GPS antenna. However, it should be understood by those skilled in the art that, on the basis of the descriptions of the present disclosure, in some other implementation scenarios, the solution provided in the present disclosure can also realize the adjustment of any two or more orders of resonant frequencies of the antenna slot structure, without being limited to the examples described in the embodiments of the present disclosure, which will not be described in detail herein.

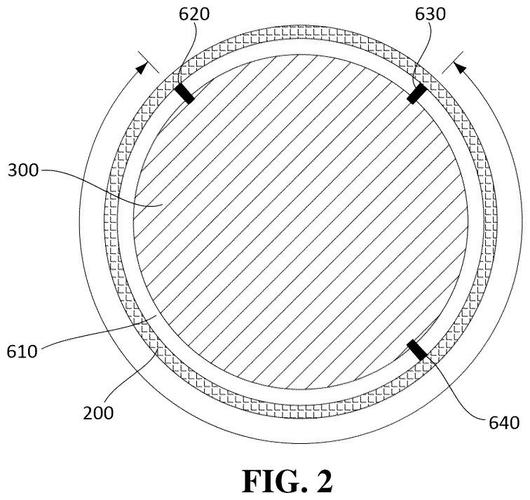

In the following, the effect of the first capacitor 640 on the first resonant frequency and the second resonant frequency will be further illustrated on the basis of the foregoing. FIG. 3 to FIG. 5 show schematic diagrams of current distribution of an example slot antenna at the first three orders of resonant frequencies in the case that the first capacitor 640 is not provided, in which darker colors indicate denser current distribution, and lighter colors indicate sparser current distribution.

FIG. 3 shows the current distribution of the slot antenna at the first-order resonant frequency. It can be seen that, the current density first gradually decreases in a direction from the feeding point A to the grounding point B, and after decreasing to zero at the point C, the current density gradually increases. That is, there is one zero point C of the current at the first-order resonant frequency. It should be noted that, if the annular slot 610 is a regular slot, the zero point C of the current at the first-order resonant frequency is typically located near a midpoint of the slot. Since the mainboard 300 is in an irregular shape in this example, the position of the zero point C of the current is slightly offset from the midpoint of the slot.

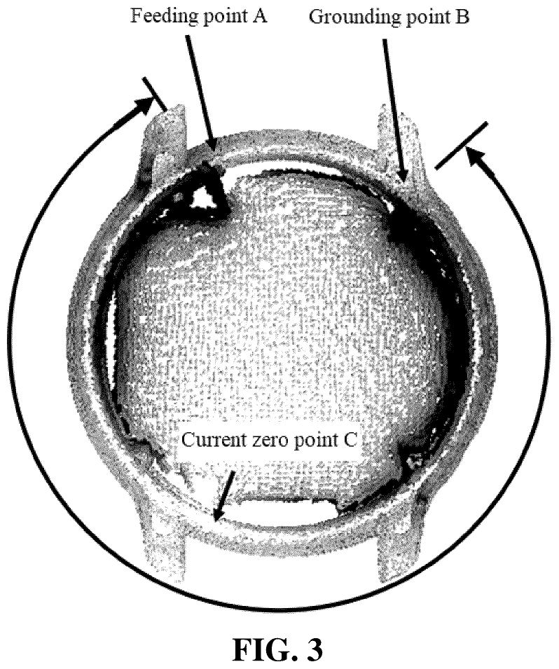

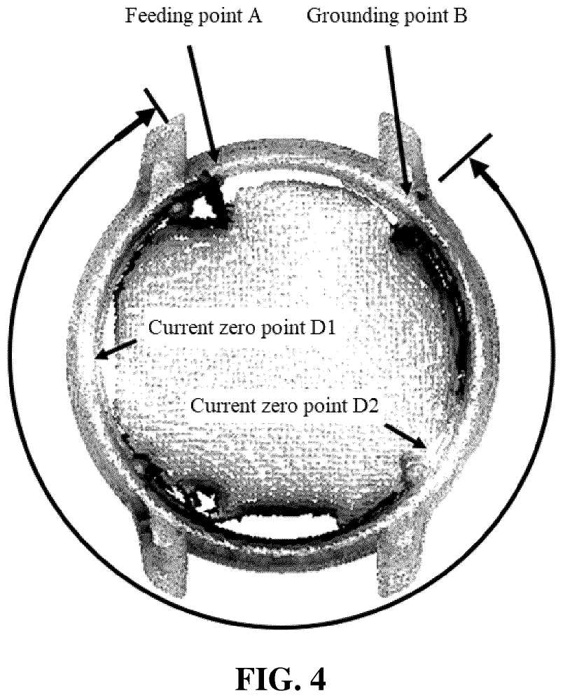

Similarly, FIG. 4 shows an example current distribution of the slot antenna at the second-order resonant frequency. It can be seen that, there are two zero points D1 and D2 of the current at the second-order resonant frequency. FIG. 5 shows an example current distribution of the slot antenna at the third-order resonant frequency. It can be seen that there are three zero points E1, E2, and E3 of the current at the third-order resonant frequency. The current distributions in FIGS. 3 to 5 also demonstrate that the three orders of resonant frequencies have the frequency multiplication relationship of f₀, 2f₀, and 3f₀.

At the resonant frequency, the voltage distribution is opposite to the current distribution, that is, the zero position of the current corresponds to the peak of the voltage, and the peak position of the current is the zero position of the voltage. According to the operating principle of the capacitor, the greater the difference between voltages applied to the two electrodes of the capacitor, the stronger the effect of the capacitor on reducing the resonant frequency. Accordingly, if the first capacitor 640 is provided at a position where the voltage value is zero at a certain order of resonant frequency (i.e., a certain resonant mode), the first capacitor 640 has no effect on reducing that certain order of resonant frequency. In addition, the position of the first capacitor 640 should satisfy the following condition: the greater the voltage value at the position of the first capacitor 640, the greater the shift of that order of resonant frequency towards lower frequencies.

Based on the above description, when adjusting the first resonant frequency, it should be ensured that the second resonant frequency is not affected or is affected as little as possible. Therefore, in this example, the first capacitor 640 is located at a position where the voltage is zero at the second resonant frequency and the voltage is nonzero at the first resonant frequency.

With continued reference to FIGS. 4 and 5, it can be seen that, the zero points D1 and D2 of the current at the first resonant frequency approximately correspond to the current peaks at the second resonant frequency, i.e., the zero points of the voltage at the second resonant frequency correspond to the zero points D1 and D2 of the current at the first resonant frequency, and therefore, the first capacitor 640 can be provided at one of D1 and D2.

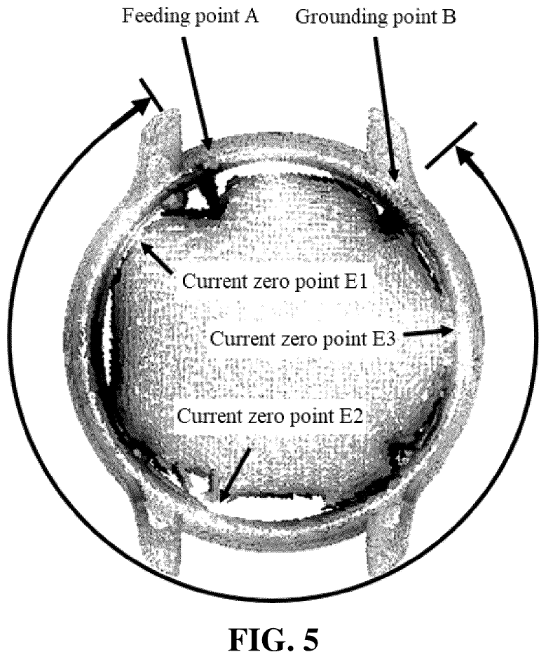

FIG. 6 shows a graph of an example change in an S-parameter (return loss) of the antenna with the first capacitor 640 provided at the position of D2. First, comparing the curves in the case that the first capacitor 640 is not provided and in the case that the first capacitor 640 of 1.5 pF is provided, it can be seen that, the original value of the first resonant frequency of the antenna is about 1.32 GHz, and after the capacitor of 1.5 pF is provided at the position of D2, the first resonant frequency is shifted towards a lower frequency of about 1.25 GHz, while the second resonant frequency of the antenna is almost unchanged, which is in accordance with the above discussion.

Further, comparing the curves in the case that the capacitor of 1.5 pF is applied and in the case that the capacitor of 2.7 pF is applied, it can be seen that, the original value of the first resonant frequency of the antenna is about 1.32 GHz, the first resonant frequency is shifted towards a lower frequency of about 1.25 GHz after the capacitor of 1.5 pF is applied at the position of D2, and the first resonant frequency is shifted towards a lower frequency of about 1.18 GHz after the capacitor of 2.7 pF is applied at the position of D2, while the second resonant frequency of the antenna is almost unchanged. Meanwhile, it can be seen from FIG. 6 that the S-parameters of the antenna are all below-10 dB, which exhibits a good antenna performance and meets the requirements of the GPS satellite positioning system for the watch.

As can be seen from the above, when the first resonant frequency is adjusted with the first capacitor 640, the following conditions can be satisfied: the first capacitor 640 is provided near the zero point of the voltage at the second resonant frequency, such that the first resonant frequency is independently adjusted without affecting the second resonant frequency. The larger the capacitance value of the first capacitor 640, the greater the shift of the first resonant frequency towards lower frequencies. Based on these conditions, those skilled in the art can realize the adjustment of the first resonant frequency.

In the following, the effect of the first inductor 630 on the resonant frequency of the antenna will be illustrated.

According to the aforementioned description, grounding the slot antenna through the first inductor 630 is equivalent to increasing the effective electrical length of the slot antenna, such that the multiple orders of the resonant frequencies of the antenna are shifted towards lower frequencies. On this basis, it is possible to design some dual-band slot antennas, and according to the present disclosure, the first inductor 630 may also be used to achieve independent adjustment of the second resonant frequency band, e.g., without affecting the first resonant frequency band, making it possible to realize the dual-band GPS antenna for the apparatus, which will be described in detail below.

First, it can be known from the foregoing that, the first resonant frequency can be independently adjusted with the first capacitor 640. Therefore, in some design of dual-band slot antennas, the second resonant frequency band of the antenna is adjusted to the target frequency by applying the first inductor 630 to the ground, and then the first resonant frequency is independently adjusted to the target frequency with the first capacitor 640 based on the above description, so as to realize the dual-band slot antenna.

However, it is more difficult to realize the dual-band GPS antenna. For example, when the second resonant frequency is adjusted to around 1.575 GHz with the first inductor 630, it is possible that the first resonant frequency is already below 1.176 GHZ, and the first capacitor 640 is used to shift the first resonant frequency towards lower frequencies, thus the dual-band GPS antenna cannot be realized. Based on this, further study has been conducted on the independent adjustment of the second resonant frequency with the first inductor 630, as discussed below.

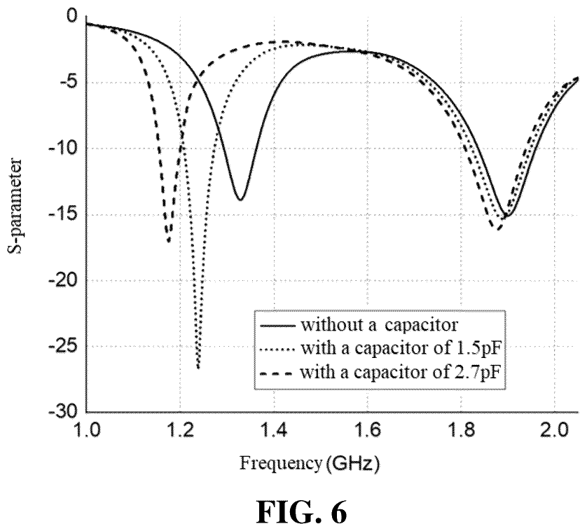

FIG. 7 shows the current distribution at the first resonant frequency after the first capacitor 640 is applied at the position of D2. It can be seen that, the current distribution in the direction of the slot length from the feeding terminal 620 to the first capacitor 640 is the same as that described above, while there is almost no current distribution in the direction of the slot length from the first capacitor 640 to the first inductor 630. Our research has showed that, this is due to the fact that the application of the first capacitor 640 creates a cutoff of the current at the first resonant frequency, such that the current is concentrated in the slot on the left side of the first capacitor 640, and only a small amount of current passes through the slot on the right side of the first capacitor 640. As the capacitance value of the first capacitor 640 increases, the cutoff effect of the first capacitor 640 on the current at the first resonant frequency becomes more pronounced. Moreover, since the first capacitor 640 is located at the zero position of the voltage at the second resonant frequency, it does not affect the current distribution at the second resonant frequency.

On this basis, in the case that the first inductor 630 is changed, the first inductor 630 has little effect on the change of the first resonant frequency, because there is only a small amount of current distribution near the first inductor 630 at the first resonant frequency, and the first inductor 630 has less effect on the first resonant frequency as the capacitance value of the first capacitor 640 increases.

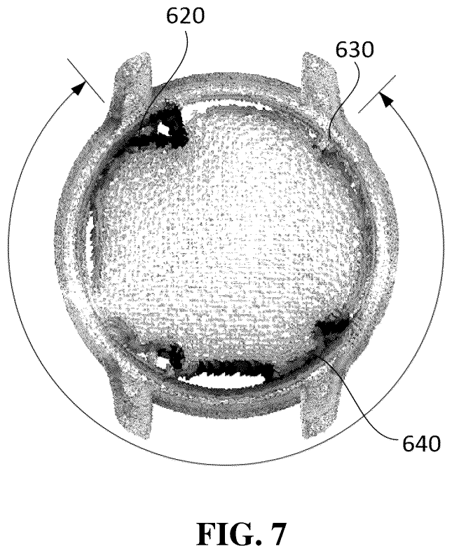

FIG. 8 shows a graph of an example change in the S-parameter of the antenna by the first inductor 630 in the case that the first capacitor 640 of 1.5 pF is provided at the position of D2. Comparing the curves in the case that an inductor is not provided and in the case that the inductor of 3.3 nH is provided, it can be seen that the second resonant frequency is about 1.9 GHz in the case that the antenna is not grounded through the first inductor 630, while the second resonant frequency is shifted towards lower frequencies to about 1.7 GHz in the case that the first inductor 630 of 3.3 nH is provided, and the first resonant frequency does not change significantly.

Furthermore, the curves in the case that the inductor of 3.3 nH is applied and in the case that the inductor of 6.8 nH is applied show that, the second resonant frequency is shifted towards lower frequencies to about 1.7 GHz in the case that the first inductor 630 of 3.3 nH is applied, while the second resonant frequency is shifted towards lower frequencies to about 1.6 GHz in the case that the first inductor 630 of 6.8 nH is applied, and there is no significant change in the first resonant frequency. Moreover, as shown in FIG. 8, the S-parameters of the antenna are all below-10 dB, which exhibits a good antenna performance and meets the requirements of the GPS satellite positioning system for the watch.

As can be seen from the above, when the second resonant frequency is adjusted with the first inductor 630, the following conditions can be satisfied: the first capacitor 640 is provided near the zero point of the voltage at the second resonant frequency, and the second resonant frequency can be independently adjusted by means of grounding through the first inductor 630, without affecting the first resonant frequency. The larger the inductance value of the first inductor 630, the greater the shift of the second resonant frequency towards lower frequencies. Based on the guidance of these descriptions, those skilled in the art can realize the adjustment of the second resonant frequency.

Based on the above, it can be understood that the implementation of adjusting the first resonant frequency and the second resonant frequency band of the antenna through the first capacitor 640 and the first inductor 630. The design of the dual-band GPS antenna will be described with reference to some nonlimiting examples below.

Firstly, a typical slot antenna structure is designed in the allowable space of the watch, such that the second-order resonant frequency of the slot antenna structure is as close as possible to and greater than 1.176 GHz, and the third-order resonant frequency is as close as possible to and greater than 1.575 GHz. Then, the first capacitor 640 is applied at the zero point of the voltage at the third-order resonant frequency, and the center frequency of the second-order resonance is adjusted to around 1.176 GHz by adjusting the position and the capacitance value of the first capacitor 640. The antenna is grounded through the first inductor 630 at the grounding point of the antenna, and the center frequency of the third-order resonance is adjusted to around 1.575 GHz by adjusting the inductance value of the first inductor 630, so as to realize the dual-band GPS slot antenna.

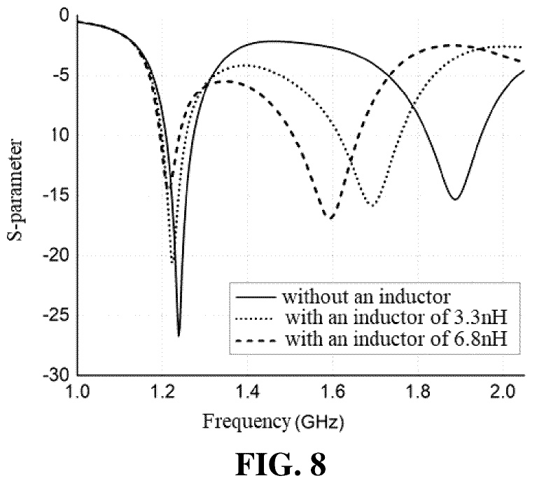

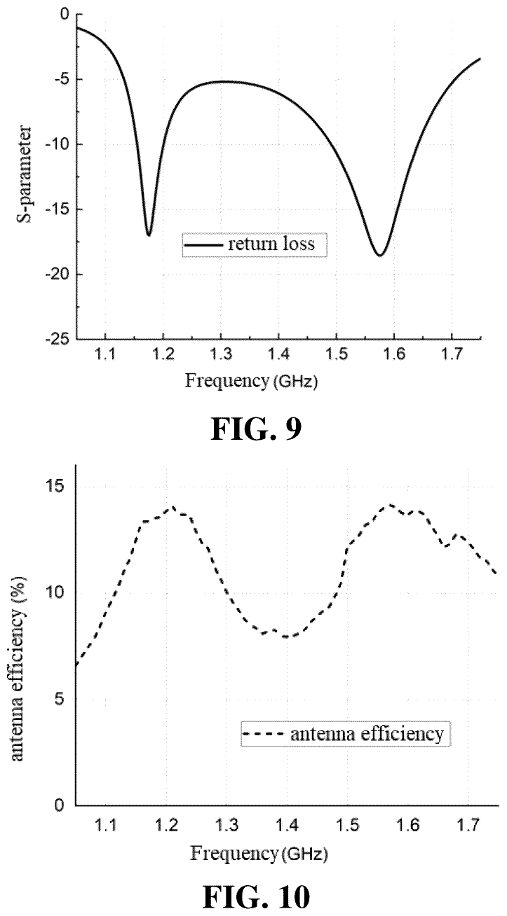

FIG. 9 shows a graph of the S-parameter of the dual-band GPS slot antenna in this example. As shown in FIG. 9, the first resonant frequency band of the antenna structure in this example covers the L5 frequency band of the GPS from 1.150 GHz to 1.2 GHz, and the second resonant frequency covers the L1 frequency band of the GPS from 1.560 GHz to 1.620 GHz, where the antenna has a good return loss. FIG. 10 shows a graph of the efficiency of the antenna in this example. It can be seen that the total efficiency of the antenna in this example is greater than 13% in both of the above frequency bands of the GPS, which can meet the requirements for the performance of dual-band GPS antennas in wearable devices.

As can be seen from the above, the apparatus with the slot antenna in this embodiment adjusts two orders of resonant frequencies of the antenna with the first capacitor and the first inductor, respectively, such that the requirements of the dual-band GPS antenna can be met by using a same antenna structure. Meanwhile, the dual-band GPS antenna is realized by using the second-order resonant frequency and the third-order resonant frequency of which the frequency multiplication relationship is closer to each other, which is more conducive to the design of the dual-band GPS antenna.

In the above embodiment, the structure and implementations of the slot antenna according to the present disclosure have been described by using the dual-band GPS antenna as an example. It should be understood that, however, the slot antenna according to the present disclosure is not limited to the dual-band antenna, and an antenna operating at more orders of resonant frequencies can be realized.

In some embodiments, still taking the aforementioned smartwatch as an example, the smartwatch often needs to establish a communication connection with a smart phone through Bluetooth or WiFi, and thus a Bluetooth/WiFi antenna, that is, an antenna with an operating frequency band adapted for Bluetooth or Wifi communications, is needed. In this embodiment, it is considered that the center frequency of the Bluetooth/WiFi antenna is 2.4 GHz, which is approximately twice the center frequency of the L5 frequency band of the GPS, and a fourth-order resonant frequency of the slot antenna is exactly twice the second-order resonant frequency.

Therefore, in addition to the first resonant frequency and the second resonant frequency described above, the slot antenna of the watch includes a third resonant frequency in the embodiment of the present disclosure, and the third resonant frequency is optionally the fourth-order resonant frequency of the slot antenna. That is, the operating frequencies of the slot antenna include: the L5 frequency band of the GPS realized with the first resonant frequency, the L1 frequency band of the GPS realized with the second resonant frequency, and the Bluetooth/WiFi frequency band realized with the third resonant frequency. Therefore, for the smartwatch, the dual-band GPS antenna and the Bluetooth/WiFi antenna can be realized by using a same slot antenna structure without providing another separate Bluetooth/WiFi antenna, and it can be realized by connecting an RF circuit of the Bluetooth/WiFi antenna to the dual-band GPS antenna through a combiner, which simplifies the internal stacking design of the watch.

The apparatus in the present disclosure realizes the adjustment of two orders or multiple orders of the resonant frequencies through the first capacitor and the first inductor, thereby realizing a dual-band GPS slot antenna, or a dual-band GPS and Bluetooth/WiFi slot antenna. Based on the description, those skilled in the art can understand that the embodiments of the present disclosure are not limited to the dual-band GPS antenna in the above embodiment, but also applicable to any other dual-band or multi-band antenna suitable for implementation.

For example, in some embodiments, a dual-band or multi-band slot antenna for GPS and Bluetooth multiplexing, GPS and 4G LTE multiplexing, Bluetooth and 4G/5G multiplexing, or 4G and 5G multiplexing can be realized according to the implementations of the above description, and the type of the antenna is not limited to the examples or embodiments described in the present disclosure.

In some other embodiments, the structure of the slot antenna in the apparatus of the present disclosure is not limited to the embodiments shown above.

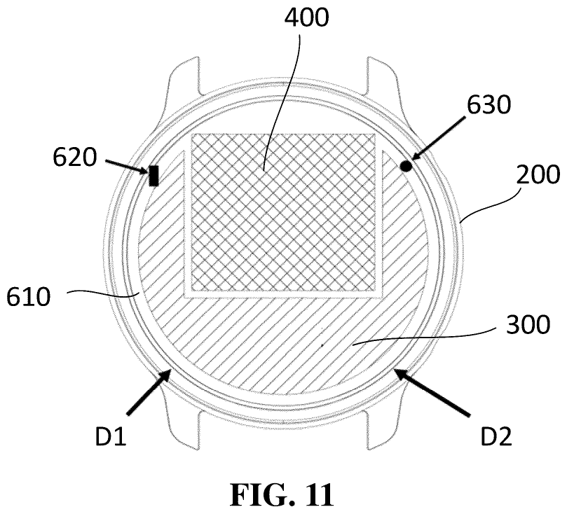

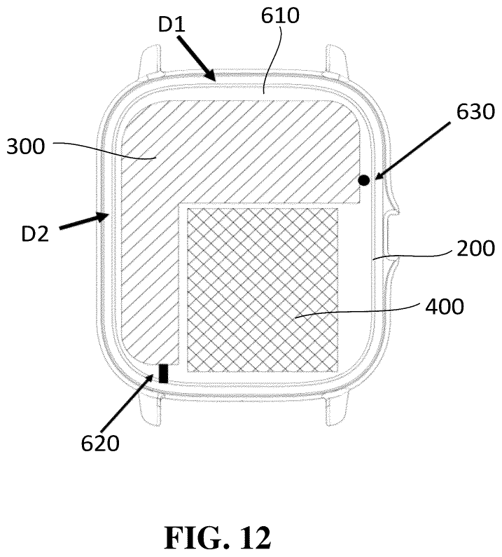

In some examples, the apparatus includes a mainboard and a first conductor, the first conductor being arranged opposite to the mainboard, such that a gap between the first conductor and the mainboard forms a radiation slot. For instance, as shown in FIG. 1A, the first conductor is or includes the conductive metal middle frame 200, and the annular slot is formed by the gap between the mainboard 300, which has a complete roundish shape in FIG. 1A, and an inner surface of the metal middle frame 200, which is arranged around a circumference of the mainboard 300. In the example shown in FIG. 11, the annular slot 610 may be formed by the mainboard 300, which has an incomplete shape in FIG. 11, and the metal middle frame 200. In the example in FIG. 12, the shape of the apparatus is not limited to annular, but can be any other shape suitable for implementation, such as a rectangle, rounded rectangle or the like. This is not limited in the present disclosure, and can be understood and implemented by those skilled in the art based on the foregoing embodiments, which will not be repeated in the present disclosure.

In some other examples, as shown in FIG. 1B, the first conductor is or includes the conductive metal bezel 210, and the annular slot is formed by the gap between the mainboard 300 and an inner surface of the metal bezel 210, which is arranged around and above a circumference of the mainboard 300.

In some other examples, the apparatus may include a second conductor electrically connected to the grounding unit of the apparatus (e.g., the grounding unit of the mainboard), and the slot is provided on the second conductor. In particular, the second conductor may be at least a part of a conductive housing, such as, for example, all-metal housing of the smartwatch. For instance, an outer middle frame and the bottom case of the smartwatch are both made of metal materials, and the metal housing is electrically connected to the grounding unit of the mainboard, such that the housing is equivalent to the ground. For another instance, the outer middle frame and the bezel of the smartwatch are both made of metal materials, and the outer middle frame is electrically connected to the grounding unit of the mainboard, such that the middle frame is equivalent to the ground. The radiation slot of the slot antenna is provided on the housing, (e.g., around the middle frame of the watch), such that the slot antenna structure of the present disclosure can also be realized. The implementation of the antenna structure in this example is the same or similar as the foregoing, which can be understood and implemented by those skilled in the art, and will not be repeated in the present disclosure.

As can be seen from the foregoing, with the apparatus according to the embodiments of the present disclosure, the first inductor and the first capacitor are configured to adjust the multiple orders of resonant frequencies of the slot antenna, such as, for example, to adjust two different orders of resonant frequencies of the slot antenna, such that the slot antenna having multiple available frequency bands is realized with a same antenna structure, and thus the multi-band slot antenna is realized.

In the apparatus according to some embodiments of the present disclosure, the operating frequencies of the slot antenna can include the first resonant frequency and the second resonant frequency, where the first resonant frequency is the second-order resonant frequency for realizing the L5 radiation frequency band of the GPS, and the second resonant frequency is the third-order resonant frequency for realizing the L1 radiation frequency band of the GPS. The dual-band GPS antenna can be realized with the third-order resonant frequency and the second-order resonant frequency having a frequency multiplication relationship close to that between the L1 and L5 frequency bands of the GPS, which is more conducive to the adjustment of the resonant frequencies of the antenna and simplifies the design process.

In the apparatus according to the embodiments of the present disclosure, the operating frequencies of the slot antenna further include the third resonant frequency, where the third resonant frequency is the fourth-order resonant frequency for realizing the radiation frequency band of the Bluetooth/WiFi antenna. The frequency multiplication relationship between the L5 frequency band of the GPS and the Bluetooth/WiFi frequency band is closer to the frequency multiplication relationship between the first resonant frequency and the third resonant frequency, thus the Bluetooth/WiFi frequency band is realized with the third resonant frequency. That is, the dual-band GPS antenna and Bluetooth/WiFi antenna are both realized with a same antenna structure without providing an additional Bluetooth/WiFi antenna, which simplifies the internal structure of the apparatus.

According to some embodiments of the present disclosure, the operating frequencies of the slot antenna include at least two orders of resonant frequencies (i.e., resonant frequency bands of at least two resonant modes), which may be independently adjusted by the first capacitor and the first inductor.

In some embodiments, the first capacitor is located at a position where a voltage value is zero at one order of the resonant frequencies (e.g., the second resonant frequency band, which is the resonant frequency band of the second resonant mode) and a voltage value is nonzero at the other order of the resonant frequencies (e.g., the first resonant frequency band, which is the resonant frequency band of the first resonant mode), such that the one order of the resonant frequencies (e.g., the first resonant frequency band) can be independently adjusted with the first capacitor without affecting the other order of the resonant frequencies (e.g., the second resonant frequency band). Moreover, under the effect of the first capacitor, one order of the resonant frequencies (e.g., the second resonant frequency band) is independently adjusted through the inductance value of the first inductor, which is more conducive to the design of the dual-band antenna.

In some embodiments, the apparatus is a wearable device (e.g., wrist-worn device), and the radiation slot of the slot antenna may be realized either by using a mainboard and a side portion (e.g., metal middle frame) of the housing of the wearable device, or by using a gap on a metal housing, so as to provide more design options for antenna design of wearable devices with metal housings.

In some embodiments, an operating frequency of the slot antenna includes at least two orders of resonant frequencies, and the first capacitor and the first inductor are configured to adjust at least one order of resonant frequency of the operating frequency. For example, the first capacitor and the first inductor are configured to adjust two different resonant frequency bands (i.e., resonant frequency bands of two different resonant modes) to corresponding target frequency bands.

In some embodiments, an operating frequency of the slot antenna includes a first resonant frequency and a second resonant frequency.

In some embodiments, the first resonant frequency band is the second-order resonant frequency of the slot antenna, and the second resonant frequency band is the third-order resonant frequency of the slot antenna.

In some embodiments, the first capacitor is configure to adjust the first resonant frequency band without or with little effect on the second resonant frequency band, and the first inductor is configured to adjust the second resonant frequency band without or with little effect on the first resonant frequency band.

In some embodiments, the first resonant frequency band includes an L5 frequency band of a GPS satellite positioning system, and the second resonant frequency band includes an L1 frequency band of the GPS satellite positioning system.

In some embodiments, the operating frequency of the slot antenna further includes a third resonant frequency band, the third resonant frequency band including a Bluetooth/WiFi operating frequency band.

In some embodiments, the third resonant frequency band is a fourth-order resonant frequency of the slot antenna.

In some embodiments, the first capacitor is located at a position where a voltage value at one order of resonant frequency (i.e., one resonant mode) is zero and a voltage value at the other order of resonant frequency (i.e., the other resonant mode) is nonzero in the length direction of the radiation slot.

In some embodiments, the first capacitor is located at a position where a voltage value at the second resonant frequency band is zero and a voltage value at the first resonant frequency band is nonzero in the length direction of the radiation slot.

In some embodiments, the slot antenna is a half-wavelength slot antenna.

In some embodiments, the apparatus further includes a mainboard including the grounding unit and the radio-frequency circuit.

In some embodiments, the apparatus further includes a first conductor arranged opposite to the mainboard, where a gap between the first conductor and the mainboard forms the radiation slot.

In some embodiments, the first conductor includes at least a part of the housing, or the housing includes the first conductor.

In some embodiments, the housing of the apparatus includes a bottom case and a side portion, and the first conductor includes at least a part of the side portion, or the side portion includes the first conductor.

In some embodiments, the side portion of the housing includes the middle frame and optionally further includes the bezel.

In some embodiments, the first conductor includes the middle frame of the apparatus.

In some embodiments, the first conductor includes the bezel of the apparatus.

In some embodiments, the apparatus further includes a second conductor electrically connected to the grounding unit, and the radiation slot is provided on the second conductor.

In some embodiments, the apparatus is a wearable device.

In some embodiments, the apparatus includes a conductive middle frame, where the conductive middle frame forms the first conductor, and is arranged around an outer side of the mainboard, and a gap between the middle frame and the mainboard forms the radiation slot.

In some embodiments, the apparatus includes a conductive bezel, where the conductive bezel forms the first conductor, and is arranged around an upper side of the mainboard, and the radiation slot. is formed by a gap between the bezel and the mainboard.

In some embodiments, the apparatus includes a conductive housing, where the housing forms the second conductor, the mainboard is provided inside the housing, a grounding unit of the mainboard is electrically connected to the housing, and the radiation slot is provided on the housing.

In some embodiments, the radiator slot is formed by a gap between the middle frame and the bezel.

In some embodiments, the conductor includes a first conductor portion and a second conductor portion, with a gap provided between the first conductor portion, and the gap forms the radiation slot.

In some embodiments, the first conductor portion is the middle frame and the second conductor portion is the bezel.

In some embodiments, the wearable device includes a wrist-worn device.

In some embodiments, the apparatus includes the slot formed in the apparatus. The feeding terminal and the first inductor are both connected to both ends of the slot in the length direction. The feeding terminal is directly connected to the radio-frequency circuit of the apparatus to form an excitation source of an antenna. The first inductor is connected to the grounding unit of the apparatus, that is, the antenna is grounded via the first inductor, such that an effective electrical length of the slot antenna is increased, and the required length of the slot is shorter for realizing the antenna with a same operating frequency, thereby reducing the space in the apparatus occupied by the antenna slot. The first capacitor is provided between the feeding terminal and the first inductor. A frequency multiplication relationship among the multiple orders of resonant frequencies can be adjusted by adjusting a position of the first capacitor in accordance with a voltage distribution relationship at the multiple orders of the resonant frequencies, so as to adjust the multiple orders of the resonant frequencies to available operating frequencies, and to meet the requirements of multiple operating frequencies with a single antenna radiation structure.

In some embodiments, a single feeding terminal and a single grounding terminal are provided in the antenna slot structure.

In some embodiments, a single feeding terminal and a plurality of grounding terminals are provided in the antenna slot structure.

In some embodiments, the feeding terminal is integrally provided with the conductor (e.g., the first conductor, the first/second conductor portion, etc.) and connected to the mainboard via an elastic member.

In some embodiments, the grounding terminal is integrally provided with the conductor (e.g., the first conductor, the first/second conductor portion, etc.) and connected to the mainboard via an elastic member.

In some embodiments, the apparatus includes a mainboard including a grounding unit and a radio-frequency circuit; a conductor electrically connected to the mainboard, an annular radiation slot being provided on the conductor; a feeding terminal, the feeding terminal having a first end connected to a feeding point of the conductor, and a second end electrically connected to the radio-frequency circuit of the mainboard; a first inductor, the first inductor having a first end connected to a grounding point of the conductor, and a second end electrically connected to the grounding unit of the mainboard; and a first capacitor provided in the annular radiation slot and having two electrodes respectively connected to both ends of the annular radiation slot in a width direction of the annular radiation slot, wherein the first capacitor is located between the feeding terminal and the first inductor in a length direction of the annular radiation slot. An operating frequency of the slot antenna includes a resonant frequency band of each of at least two resonant modes of the annular radiation slot.

In some embodiments, by positioning of at least one of the first capacitor or the first inductor at a selected location along the annular radiation slot, a resonant frequency band of a resonance mode is independently adjusted without affecting another resonance mode.

In some embodiments, an operating frequency of the slot antenna of the apparatus includes a resonant frequency band of a first resonant mode and a resonant frequency band of a second resonant mode, the first capacitor is configured to adjust the resonant frequency band of the first resonance mode without affecting the second resonance mode, and the first inductor is configured to adjust the resonant frequency band of the second resonance mode without affecting the first resonance mode.

In some embodiments, a first portion of the annular radiation slot between the feeding terminal and the first inductor is longer than a second portion of the annular radiation slot between the feeding terminal and the first inductor, and the first capacitor is located in the first portion.

In some embodiments, an operating frequency of the slot antenna includes a resonant frequency band of a first resonant mode and a resonant frequency band of a second resonant mode, the resonant frequency band of the first resonant mode including an L5 frequency band of a GPS satellite positioning system, and the resonant frequency band of the second resonant mode including an L1 frequency band of the GPS satellite positioning system.

In some embodiments, the operating frequency of the slot antenna further includes a resonant frequency band of a third resonant mode, the resonant frequency band of the third resonant mode including an operating frequency band adapted for Bluetooth or Wifi communications.

In some embodiments, an original resonant frequency band of the first resonant mode and an original resonant frequency band of the second resonant mode have a frequency multiplication relationship close to that between the L1 and L5 frequency bands of the GPS satellite positioning system.

In some embodiments, the first conductor is disposed entirely above the mainboard in a direction perpendicular to a plane of the mainboard, or the first conductor extends in the direction perpendicular to the plane of the mainboard to at least the plane of the mainboard.

In some embodiments, the first capacitor is located at a position along the length direction of the annular radiation slot where a voltage value for a resonant mode is zero and a voltage value for another resonant mode is nonzero.

In some embodiments, an operating frequency of the slot antenna includes a resonant frequency band of a first resonant mode and a resonant frequency band of a second resonant mode, wherein the first resonant mode is a second-order resonant of the slot antenna, and the second resonant mode is a third-order resonant of the slot antenna.

In some embodiments, the apparatus includes a housing having a conductive portion and an insulating portion, wherein the conductor includes at least a part of the conductive portion.

In some embodiments, the housing includes a middle frame and an insulating bottom cover, and the conductive portion is attached to a surface of the middle frame.

In some embodiments, the apparatus includes an annular radiation slot formed in the apparatus; a feeding terminal, the feeding terminal having a first end connected to a feeding point of the slot antenna, and a second end electrically connected to a radio-frequency circuit of the apparatus; a first inductor, the first inductor having a first end connected to a grounding point of the slot antenna, and a second end electrically connected to a grounding unit of the apparatus; and a first capacitor provided in the annular radiation slot and having two electrodes respectively connected to both ends of the annular radiation slot in a width direction of the annular radiation slot, wherein the first capacitor is located between the feeding terminal and the first inductor in a length direction of the annular radiation slot, wherein an operating frequency of the slot antenna includes a resonant frequency band of each of at least two resonant modes of the annular radiation slot.

In some embodiments, the apparatus further includes a mainboard; and a conductor electrically connected to the mainboard, wherein an annular radiation slot is provided on the conductor;

In some embodiments, by positioning of at least one of the first capacitor or the first inductor at a selected location along the annular radiation slot, a resonant frequency band of a resonance mode is independently adjusted without affecting another resonance mode.

In some embodiments, an operating frequency of the slot antenna includes a resonant frequency band of a first resonant mode and a resonant frequency band of a second resonant mode, the first capacitor is configured to adjust the resonant frequency band of the first resonance mode without affecting the second resonance mode, and the first inductor is configured to adjust the resonant frequency band of the second resonance mode without affecting the first resonance mode.

In some embodiments, a first portion of the annular radiation slot between the feeding terminal and the first inductor is longer than a second portion of the annular radiation slot between the feeding terminal and the first inductor, and the first capacitor is located in the first portion.

In some embodiments, an operating frequency of the slot antenna includes a resonant frequency band of a first resonant mode and a resonant frequency band of a second resonant mode, the resonant frequency band of the first resonant mode including an L5 frequency band of a GPS satellite positioning system, and the resonant frequency band of the second resonant mode including an L1 frequency band of the GPS satellite positioning system.

In some embodiments, the first capacitor is located at a position along the length direction of the annular radiation slot where a voltage value for a resonant mode is zero and a voltage value for another resonant mode is nonzero.

It is apparent that the above embodiments are merely examples for clarity of illustration, and are not limitations on the embodiments. For those ordinary skilled in the art, other variations or modifications in different forms can be made based on the above description. It is not necessary or possible to exhaust all embodiments herein. However, obvious variations or modifications derived therefrom still fall within the protection scope of the present disclosure.

What is claimed is:

1. An apparatus with a slot antenna, comprising:
a mainboard comprising a grounding unit and a radio-frequency circuit;
a conductor, wherein an annular radiation slot is provided on the conductor;
a feeding terminal, the feeding terminal having a first end connected to a feeding point of the conductor, and a second end electrically connected to the radio-frequency circuit of the mainboard;
a first inductor, the first inductor having a first end connected to a grounding point of the conductor, and a second end electrically connected to the grounding unit of the mainboard; and
a first capacitor provided in the annular radiation slot and having two electrodes respectively connected to both ends of the annular radiation slot in a width direction of the annular radiation slot, wherein the first capacitor is located between the feeding terminal and the first inductor in a length direction of the annular radiation slot;
wherein an operating frequency of the slot antenna comprises a resonant frequency band of each of at least two resonant modes of the annular radiation slot.

2. The apparatus according to claim 1, wherein
the conductor comprises a first conductor portion arranged on one side of the annular radiation slot and a second conductor portion arranged on an opposite side of the annular radiation slot, and a closed annular radiation slot is formed by a gap between the first conductor portion and a second conductor portion.

3. The apparatus according to claim 2, further comprising:
a housing, comprising a conductive bezel and a conductive middle frame, wherein the first conductor portion is formed by the conductive bezel, and the second conductor portion is formed by the conductive middle frame.

4. The apparatus according to claim 1, further comprising:
a housing, comprising a non-conductive middle frame, wherein the conductor is attached to the middle frame; or
a housing, comprising a conductive middle frame, wherein the radiation slot is provided on the middle frame.

5. The apparatus according to claim 2, wherein
the feeding point is provided on the first conductor portion, and the grounding point is provided on the second conductor portion.

6. The apparatus according to claim 1, wherein
an operating frequency of the slot antenna comprises a resonant frequency band of a first resonant mode and a resonant frequency band of a second resonant mode,
the first capacitor is configured to adjust the resonant frequency band of the first resonance mode without affecting the second resonance mode, and
the first inductor is configured to adjust the resonant frequency band of the second resonance mode without affecting the first resonance mode.

7. The apparatus according to claim 2, further comprising an insulating ring provided in the slot between the first conductor portion and the second conductor portion.

8. The apparatus according to claim 1, wherein
an operating frequency of the slot antenna comprises a resonant frequency band of a first resonant mode and a resonant frequency band of a second resonant mode,
the resonant frequency band of the first resonant mode comprising an L5 frequency band of a GPS satellite positioning system, and the resonant frequency band of the second resonant mode comprising an L1 frequency band of the GPS satellite positioning system.

9. The apparatus according to claim 1, further comprising:
a housing, comprising a bottom case and a side portion connected to the bottom case;
wherein the conductor comprises at least a part of the side portion, or the side portion comprises at least a part of the conductor.

10. An apparatus with a slot antenna, comprising:
an annular radiation slot;
a feeding terminal, the feeding terminal having a first end connected to a feeding point of the slot antenna, and a second end electrically connected to a radio-frequency circuit of the apparatus;
a first inductor, the first inductor having a first end connected to a grounding point of the slot antenna, and a second end electrically connected to a grounding unit of the apparatus; and
a first capacitor provided in the annular radiation slot and having two electrodes respectively connected to both ends of the annular radiation slot in a width direction of the annular radiation slot, wherein the first capacitor is located between the feeding terminal and the first inductor in a length direction of the annular radiation slot,
wherein an operating frequency of the slot antenna comprises a resonant frequency band of each of at least two resonant modes of the annular radiation slot.

11. The apparatus according to claim 10, further comprising:
a mainboard, comprising the grounding unit and the radio-frequency circuit; and
a first conductor, arranged around a circumference of the mainboard;
wherein the radiation slot is formed by a gap between the first conductor and the mainboard.

12. The apparatus according to claim 10, further comprising:
a mainboard; and
a housing comprising a conductive bezel, wherein the radiation slot is formed by a gap between the conductive bezel and the mainboard.

13. The apparatus according to claim 10, further comprising:
a mainboard; and
a housing comprising a conductive middle frame, wherein the radiation slot is formed by a gap between the middle frame and the mainboard.

14. The apparatus according to claim 10, further comprising:
a housing, comprising a bottom case and a side portion connected to the bottom case; and
a mainboard;
wherein the radiation slot is formed by a gap between at least a part of the side portion and the mainboard.

15. The apparatus according to claim 10, wherein
an operating frequency of the slot antenna comprises a resonant frequency band of a first resonant mode and a resonant frequency band of a second resonant mode,
the first capacitor is configured to adjust the resonant frequency band of the first resonance mode without affecting the second resonance mode, and
the first inductor is configured to adjust the resonant frequency band of the second resonance mode without affecting the first resonance mode.

16. The apparatus according to claim 11, wherein
the first conductor is disposed entirely above the mainboard in a direction perpendicular to a plane of the mainboard, or the first conductor extends in the direction perpendicular to the plane of the mainboard to at least the plane of the mainboard.

17. The apparatus according to claim 10, wherein
an operating frequency of the slot antenna comprises a resonant frequency band of a first resonant mode and a resonant frequency band of a second resonant mode,
the resonant frequency band of the first resonant mode comprising an L5 frequency band of a GPS satellite positioning system, and the resonant frequency band of the second resonant mode comprising an L1 frequency band of the GPS satellite positioning system.

18. The apparatus according to claim 10, wherein
the first capacitor is located at a position along the length direction of the annular radiation slot where a voltage value for a resonant mode in the at least two resonant modes is zero and a voltage value for another resonant mode in the at least two resonant modes is nonzero.

19. The apparatus according to claim 10, wherein
the operating frequency of the slot antenna further comprises a resonant frequency band of a third resonant mode, the resonant frequency band of the third resonant mode comprising an operating frequency band adapted for Bluetooth or WiFi communications.

20. The apparatus according to claim 10, wherein
the apparatus is a wrist-worn device, and the slot antenna is configured for satellite positioning communication.
